(19) United States
(12) Patent Application Publication
(10) Pub. No.: US 2014/0143807 A1
(43) Pub. Date: May 22, 2014

(54) MESSAGE OUTPUTTING APPARATUS AND MESSAGE OUTPUTTING METHOD

(71) Applicant: Hiroki Monta, Osaka (JP)

(72) Inventor: Hiroki Monta, Osaka (JP)

(73) Assignee: PANASONIC CORPORATION, Osaka (JP)

(21) Appl. No.: 14/131,895

(22) PCT Filed: Mar. 6, 2012
(86) PCT No.: PCT/JP2012/001541

§ 371 Date: Jan. 9, 2014

(30) Foreign Application Priority Data
Jul. 22, 2011 (JP) 2011-160576

(51) Int. Cl. H04N 21/4788

(52) U.S. Cl. CPC H04N 21/4788
USPC 725/34

(57) ABSTRACT

A message outputting apparatus and message outputting method that can facilitate an input of a chat message by a viewer, and simultaneously attain chatting with enriched conversation contents are provided. In a TV-program viewing apparatus, a genre obtaining unit obtains TV-program information from content received by a content receiving unit. A message sample corresponding to the TV-program information is stored in a message sample storing unit, and the message sample is displayed as an input candidate. The selected message sample is transmitted via a network interface unit.

### TECHNICAL FIELD

The present invention relates to a message outputting apparatus that outputs a message while a user is viewing content.

### BACKGROUND ART

Systems for chatting on a TV-program viewing apparatus while a user is viewing broadcast content with the TV-program viewing apparatus have been proposed.

Conventionally, the broadcast content is viewed only within individual households, and it is difficult to share thoughts and opinions with people located far apart.

However, as the Internet techniques are spread, various interactive systems can be constructed, and various services are provided also on the TV-program viewing apparatus. As one example, the system for chatting on a TV-program viewing apparatus while a user is viewing broadcast content with the TV-program viewing apparatus as described above is proposed.

Here, chatting using the TV-program viewing apparatus such as televisions is slightly different in a feeling of operation from chatting using the conventional apparatus such as personal computers (PC).

The difference in the feeling of operation between chatting using the TV-program viewing apparatus such as televisions and chatting using the PC is attributed to the difference in an input interface. In the PC, input is performed using a keyboard. In the TV-program viewing apparatus, input is performed using a remote controller (remote control). Typically, the remote controller is designed into a smaller size to be handled with one hand. For this reason, the number of buttons is limited and the buttons need to be operated several times to input one single letter. Additionally, it is difficult to press the buttons with fingers of both hands successively. Namely, the remote controller is difficult to input a chat message with.

Here, for example, Patent Literature 1 discloses inputting of a canned message for allowing a viewer to easily input a chat message. This technique can save time and effort in inputting letters, leading to convenience.

### CITATION LIST

### Patent Literature

[PTL 1] Japanese Unexamined Patent Application Publication No. 2002-524935

### SUMMARY OF INVENTION

### Technical Problem

The canned chat messages as in the conventional technique cause a new problem that the freedom of conversations reduces. The messages exchanged in chatting are fixed, which may lead to obstruction of free and active discussions at which the chatting aims.

Then, the present invention is to solve the problems in the related art, and an object of the present invention is to provide a message outputting apparatus and message outputting method that can facilitate an input of a chat message by a viewer, and simultaneously attain chatting with enriched conversation contents.

### Solution to Problem

In order to attain the object above, the message outputting apparatus according to the present invention includes a message outputting apparatus that outputs a message when a user is viewing content, the message outputting apparatus including: a genre obtaining unit configured to obtain genre information of the content; a message sample storing unit configured to store one or more message samples in correspondence with the genre information; a message creating unit configured to extract at least one message sample as a message sample group from the one or more message samples stored in the message sample storing unit, based on the genre information obtained by the genre obtaining unit; a control interface unit configured to accept an input from the user; a network interface unit configured to transmit and receive data to and from an external apparatus; and a control unit configured to specify a specific message sample from the message sample group extracted by the message creating unit, based on the input from the user accepted by the control interface unit, and output data corresponding to the specific message sample to the external apparatus via the network interface unit.

Thereby, the user can create a message efficiently using a message sample group optimal to the content that the user is viewing.

Moreover, the message outputting apparatus may further include a content receiving unit configured to receive the content; and a content reproducing unit configured to reproduce a picture and TV-program information including the genre information from the content received by the content receiving unit, wherein the genre obtaining unit is configured to obtain the genre information from the TV-program information.

Moreover, the message outputting apparatus may further include a message display unit configured to display the message sample group extracted by the message creating unit.

Moreover, the message outputting apparatus may further include a picture display unit configured to generate a picture in which the picture reproduced by the content reproducing unit is synthesized with the message sample group extracted by the message creating unit.

Moreover, the message outputting apparatus may further include an external interface unit configured to transmit and receive data to and from a display device that displays the content, wherein the genre obtaining unit is configured to obtain the genre information of the content from the display device via the external interface unit, the content being displayed with the display device.

Moreover, the message outputting apparatus may further include a message sample requesting unit configured to obtain one or more message samples as the message sample group via the network interface unit from an external apparatus, based on the genre information obtained by the genre obtaining unit.

Moreover, the message sample storing unit may store the message sample in correspondence with a genre and a genre keyword. The message outputting apparatus may further include a genre keyword obtaining unit configured to obtain the genre keyword for the content. The message creating unit may extract one or more message samples as a message sample group from the one or more message samples stored in the message sample storing unit, based on the genre keyword obtained by the genre keyword obtaining unit.

Moreover, the message outputting apparatus may further include a message registering unit configured to register the message to the message sample storing unit as the message sample in correspondence with the genre based on the genre information obtained by the genre obtaining unit, the message being based on the input from the user and accepted by the control interface unit.

Moreover, the message outputting apparatus may further include a message receiving unit configured to receive a message from the external apparatus via the network interface unit; and a message registering unit configured to register the message received by the message receiving unit to the message sample storing unit as the message sample in correspondence with the genre based on the genre information obtained by the genre obtaining unit.

The present invention can be implemented not only as such a message outputting apparatus but also as a message outputting method including these characteristic units included in the message outputting apparatus as steps. The present invention can be also implemented as a program causing a computer to execute these steps. Such a program can be implemented as a recording medium such as a computer-readable CD-ROM, information indicating the program, data, or signals. These program, information, data, and signals may be distributed via a communication network such as the Internet.

### Advantageous Effects of Invention

According to the present invention, message sample groups are managed corresponding to individual genres, and a message is created efficiently using a message sample group corresponding to the genre to which the content to be viewed belongs. Thus, the present invention can attain an effect of active sharing of messages between viewers.

### BRIEF DESCRIPTION OF DRAWINGS

FIG. 1 is a block diagram showing a message outputting apparatus according to one embodiment of the present invention and its peripheral apparatuses.

FIG. 2 is a flowchart showing the operation of a TV-program viewing apparatus according to Embodiment 1.

FIG. 3 is a diagram showing one example of a data structure stored in a message sample storing unit in a TV-program display apparatus according to Embodiment 1.

FIG. 4 is an image diagram showing a display screen in the TV-program display apparatus according to Embodiment 1.

FIG. 5 is a diagram showing a table for managing information on a destination when the TV-program viewing apparatus according to Embodiment 1 exchanges messages.

FIG. 6 is a diagram showing an example in which the TV-program viewing apparatus according to Embodiment 1 is used as a system.

FIG. 7 is a diagram showing a modification of the TV-program viewing apparatus according to Embodiment 1 as the system.

FIG. 8 is a diagram showing a modification of the TV-program viewing apparatus according to Embodiment 1 as the system.

FIG. 9 is a block diagram showing a modification of the TV-program viewing apparatus according to Embodiment 1.

FIG. 10 is a diagram showing one example of a data structure stored in a genre+keyword-corresponding message sample storing unit in the TV-program display apparatus according to the modification of Embodiment 1.

FIG. 11 is an image diagram showing a display screen in the TV-program display apparatus according to a modification of Embodiment 1.

FIG. 12 is a block diagram showing a second modification of the TV-program viewing apparatus according to Embodiment 1.

FIG. 13 is a diagram showing when Addition of message is selected in the second modification of the TV-program viewing apparatus according to Embodiment 1.

FIG. 14 is a diagram showing when Addition of message is selected in the second modification of the TV-program viewing apparatus according to Embodiment 1.

FIG. 15 is a diagram showing when Addition of message is selected in the second modification of the TV-program viewing apparatus according to Embodiment 1.

FIG. 16 is a diagram showing when Addition of message is selected in the second modification of the TV-program viewing apparatus according to Embodiment 1.

FIG. 17 is a block diagram showing a third modification of the TV-program viewing apparatus according to Embodiment 1.

FIG. 18 is a block diagram showing a fourth modification of the TV-program viewing apparatus according to Embodiment 1.

FIG. 19 is a block diagram when an output from the TV-program viewing apparatus is viewed with an external apparatus.

FIG. 20 is a block diagram showing a fifth modification of the TV-program viewing apparatus according to Embodiment 1.

FIG. 21 is a block diagram showing a sixth modification of the TV-program viewing apparatus according to Embodiment 1.

FIG. 22 is a block diagram showing a configuration of a message outputting apparatus, a broadcast receiving apparatus, and peripheral apparatuses according to one embodiment of the present invention.

FIG. 23 is a diagram showing a usage example of a message outputting apparatus and broadcast receiving apparatus according to Embodiment 2.

### DESCRIPTION OF EMBODIMENTS

Hereinafter, embodiments according to the present invention will be described in detail using the drawings. The embodiments to be described below only show preferred specific examples of the present invention. Numeral values, shapes, materials, components, arrangements, positions, and connection forms of the components, steps, order of the steps, and the like shown in the embodiments below are only examples, and will not limit the present invention. The present invention is limited only by the scope of Claims. Accordingly, among the components of the embodiments below, the components not described in an independent Claim representing the most superordinate concept of the present invention are not always necessary to achieve the object of the present invention, but will be described as those that form more preferable embodiments.

### Embodiment 1

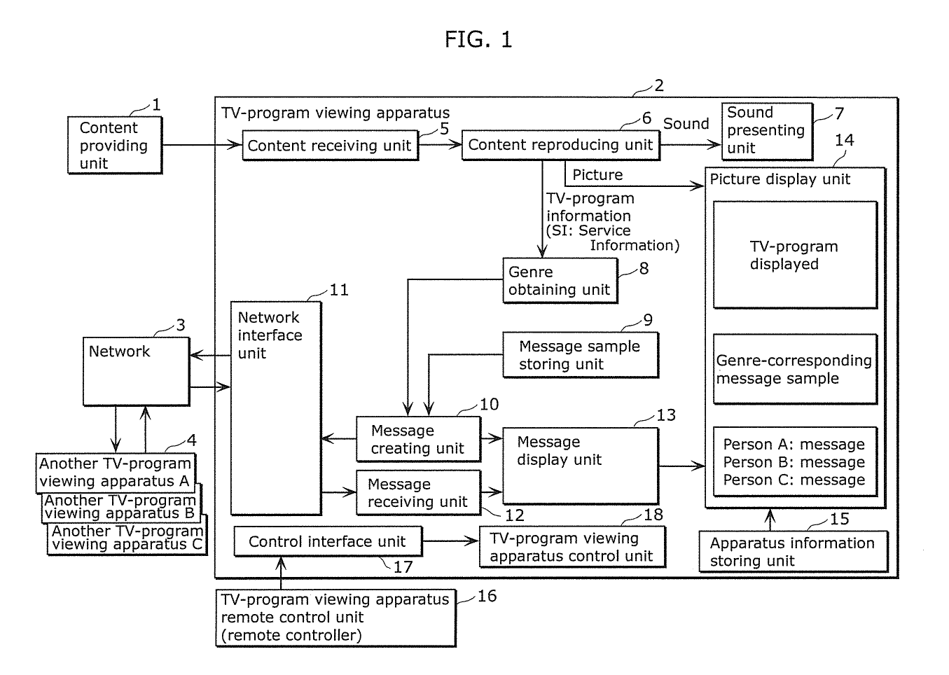

Hereinafter, the configuration of a message outputting apparatus according to one embodiment of the present invention will be described with reference to FIG. 1. In the present embodiment, the message outputting apparatus is implemented as a TV-program viewing apparatus.

FIG. 1 is a block diagram showing a configuration of the TV-program viewing apparatus and its peripheral apparatuses according to the present embodiment.

A content providing unit 1 is an apparatus that can provide content. The content includes a TV-program composed of pictures, sounds, and data other than these. Examples of the method for providing content include broadcasting and communication. Specifically, in the broadcasting, the content providing unit 1 is a broadcast station apparatus or a transponder, for example. In the communication, content providing unit 1 is a server installed by a content provider, for example.

A TV-program viewing apparatus 2 is an apparatus with which a user outputs a message when the user is viewing the content (TV-program) provided by the content providing unit 1 through the broadcasting or communication. The TV-program viewing apparatus 2 includes a content receiving unit 5, a content reproducing unit 6, a sound presenting unit 7, a genre obtaining unit 8, a message sample storing unit 9, a message creating unit 10, a network interface unit 11, a message receiving unit 12, a message display unit 13, a picture display unit 14, an apparatus information storing unit 15, a TV-program viewing apparatus remote control unit 16, a control interface unit 17, and a TV-program viewing apparatus control unit 18. Examples of the TV-program viewing apparatus 2 include television receivers, Set Top Boxes (STBs), PCs, and mobile phones. Here, the message designates chat messages, e-mails, and messages in social networking services (SNS), for example.

The network 3 is an infrastructure for connecting the TV-program viewing apparatus 2 to an external apparatus for data transfer. The network 3 is a wireless network or a wired network, for example.

Another TV-program viewing apparatus 4 is an apparatus equivalent to the TV-program viewing apparatus 2 and communicable with the TV-program viewing apparatus 2 via the network 3. The equivalent apparatus designates an apparatus having the function implemented by the present invention, and is not limited to products of the same model provided by the same manufacturer.

The content receiving unit 5 performs processing needed until the content reproducing unit 6 reproduces the content provided from the content providing unit 1. Specifically, when the content is provided through the broadcasting, the content receiving unit 5 is a front-end that performs steps such as channel selection, demodulation, and error correction. When the content is provided through the communication, the content receiving unit 5 is a network interface that can interpret the protocol. In many cases, the content receiving unit 5 is implemented by a combination of an antenna or modem with dedicated hardware or software in a Large Scale Integration (LSI), for example.

The content reproducing unit 6 decodes and reproduces the content. In the broadcasting, the content is provided in a format in which moving pictures, sounds, data on the content, and the like are multiplexed in a data string referred to as a Transport Stream (TS). In the communication, moving pictures, sounds, and data on the content each are packetized in accordance with a communication protocol. The content reproducing unit 6 distinguishes the information, and converts the information into a format interpretable by the TV-program viewing apparatus 2. Specifically, examples of the content reproducing unit 6 include a TS decorder and an MPEG decorder. In many cases, the content reproducing unit 6 is implemented by dedicated hardware or software. Examples of the data on the content include TV-program information (SI: Service Information). The SI includes the information on the genre of the TV-program. Examples of the information on the genre of the TV-program include the information indicating that the content is related to a sport program or a cooking program.

The sound presenting unit 7 functions based on the sound data decoded by the content reproducing unit 6. When a sound reproducing apparatus such as a speaker is built in the TV-program viewing apparatus 2, the sound presenting unit 7 is the speaker. When the sound reproducing apparatus such as a speaker exists as an external apparatus, the sound presenting unit 7 is a terminal that outputs audio signals.

The genre obtaining unit 8 extracts genre information from the TV-program information reproduced by the content reproducing unit 6. As an example of the extraction, the genre information can be extracted by filtering a predetermined packet in the TV-program information composed of a plurality of packets. In many cases, the genre obtaining unit 8 is implemented by dedicated hardware or software, for example.

In the message sample storing unit 9, message sample groups, that is, samples of messages, are stored in advance in correspondence with the genres. Here, the genre is a criterion for classifying the message sample groups, and desirably corresponds to the genre information extracted by the genre obtaining unit 8 from the viewpoint of simplification of the system. Alternatively, the genre, that is, the criterion for classifying the message sample groups may be defined as a superordinate concept or subordinate concept of the genre information extracted by the genre obtaining unit 8. The message sample storing unit 9 is specifically implemented by a storing device such as a Random Access Memory (RAM) and a Read Only Memory (ROM).

The message creating unit 10 extracts a specific message sample group from the message sample storing unit 9. The specific message sample group may be extracted by filtering using the genre information extracted by the genre obtaining unit 8 as a key. Alternatively, the specific message sample group may be extracted by extracting the message sample group, which is related to the genre obtained in the genre obtaining unit 8, according to the degree of relation. In many cases, the message creating unit 10 is implemented by dedicated hardware or software, for example.

The network interface unit 11 is an interface for connecting the network 3 to the TV-program viewing apparatus 2. Specifically, the network interface unit 11 is implemented by the Ethernet (registered trademark) such as 10Base-T or a wireless Local Area Network (LAN) interface, for example.

The message receiving unit 12 receives the specific message from the network interface unit 11. Specifically, the message received by the message receiving unit 12 includes the message transmitted by the another TV-program viewing apparatus 4. In many cases, the message receiving unit 12 is implemented by dedicated hardware or software, for example.

The message display unit 13 generates a picture corresponding to the message sample group. The picture corresponding to the message sample group is implemented by an On Screen Display (OSD) or a graphics in a window different from a picture window. In many cases, the message display unit 13 is implemented by dedicated hardware or software, for example.

The picture display unit 14 creates the picture data to be displayed. The picture data to be displayed includes the TV-program received by the content receiving unit 5, the program being synthesized with the picture created by the message display unit 13. Here, the synthesis of the picture refers only to synthesis to multiplex all the information. The synthesis of the picture includes the processing to generate windows corresponding to picture sources within a screen or over a plurality of screens, and display the picture source in the window. In many cases, the picture display unit 14 is implemented by dedicated hardware or software, for example. When the TV-program viewing apparatus 2 includes a display, the picture data generated by the picture display unit 14 is output to the display. When the TV-program viewing apparatus 2 includes a display connected to the TV-program viewing apparatus 2 wiredly or wirelessly, the picture data generated by the picture display unit 14 is output to the display.

In the apparatus information storing unit 15, the data on apparatus setting in the TV-program viewing apparatus 2 is stored. The data on apparatus setting in the TV-program viewing apparatus 2 stored in the apparatus information storing unit 15 includes a table of destination information described later. The apparatus information storing unit 15 is specifically implemented by a non-volatile memory such as a RAM and a ROM.

The operating unit 16 is an interface for inputting to the TV-program viewing apparatus 2 by a person. Typically, the operating unit 16 is a remote controller, buttons included in the TV-program viewing apparatus 2, and a mobile phone associated with the TV-program viewing apparatus 2, for example. In the present embodiment, the input is performed with a remote controller (TV-program viewing apparatus remote control unit), and the operating unit 16 is expressed as a TV-program viewing apparatus remote control unit 16 in the drawings.

The control interface unit 17 is an interface for accepting the input from the operating unit 16 on the side of the TV-program viewing apparatus 2. The control interface unit 17 decodes the input from the operating unit 16 into a format of a command interpretable by the TV-program viewing apparatus 2. In many cases, the control interface unit 17 is implemented by dedicated hardware.

The TV-program viewing apparatus control unit 18 interprets the command input from the control interface unit 17, and controls the functional blocks in the TV-program viewing apparatus 2 described above. The output from the TV-program viewing apparatus control unit 18 is connected to the functional blocks in the TV-program viewing apparatus 2, but not shown to avoid complexity of the diagram. Examples of the control of the storing blocks in the TV-program viewing apparatus 2 by the TV-program viewing apparatus control unit 18 include management of a storing region such as a RAM and a ROM, and management of the timings to input and output the data, management of interrupt control. In many cases, the TV-program viewing apparatus control unit 18 is implemented by a general-purpose or dedicated CPU.

### (Operation of Apparatus)

The operation of the thus-configured TV-program viewing apparatus to input a message for a TV-program from a user (hereinafter referred to as a viewer) of the TV-program viewing apparatus, transmit the message to the outside, and simultaneously receive another message for the TV-program and present the message will be described.

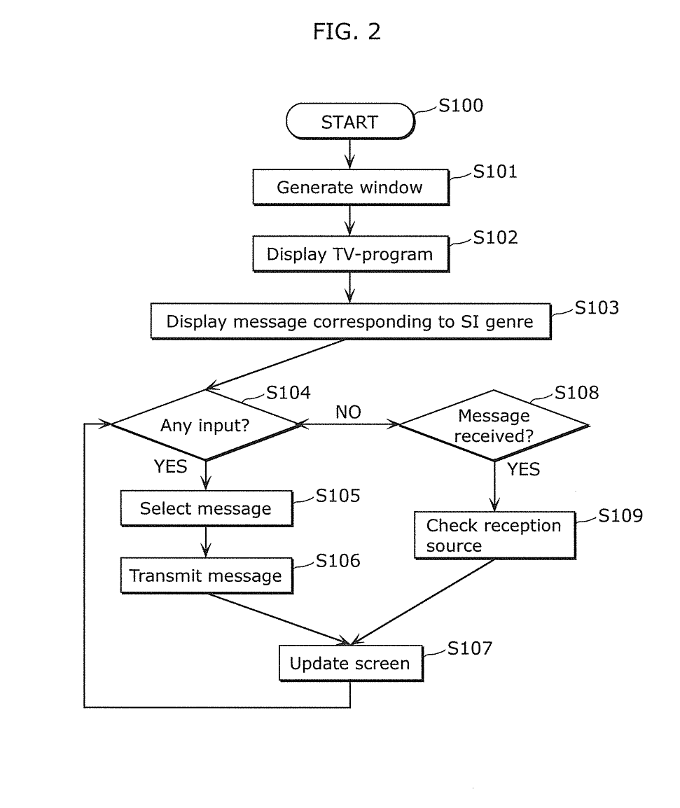

FIG. 2 is a flowchart showing a flow of the operation of the TV-program viewing apparatus according to Embodiment 1. Hereinafter, with reference to FIG. 2, the operation of the TV-program viewing apparatus will be described.

Here, one example of the operation of the TV-program viewing apparatus will be described. Namely, the operation does not cover all the operation of the TV-program viewing apparatus according to the present invention.

Step S100 is a step before the message is exchanged between the TV-program viewing apparatus 2 and another TV-program viewing apparatus 4. Namely, in Step S100, a scene is assumed, for example, the power supply of the TV-program viewing apparatus 2 is turned on, or a chat application or an application equivalent to the chat application (such as an instant messenger) is launched while the TV-program viewing apparatus 2 is being used.

Step S101 is a window generation operation. The window generation operation is an operation of the picture display unit 14 to generate the picture data to display a plurality of windows in the display screen of the TV-program viewing apparatus 2 or display connected to the outside. The step can be omitted when the picture display unit 14 does not synthesize the TV-program or the message in window units but synthesizes the TV-program or the message as the OSD synthesis of the data.

Step S102 is a TV-program display operation. The TV-program display operation is an operation of the content receiving unit 5 in the TV-program viewing apparatus 2 to receive the content from the content providing unit 1, and display the picture reproduced by the content reproducing unit 6 in the picture display unit 14 and present the sound reproduced by the content reproducing unit 6 in the sound presenting unit 7. When the plurality of windows is generated in Step S101 and a picture is displayed in the picture display unit 14, the picture is displayed in part of the plurality of windows generated in the Step S101 above.

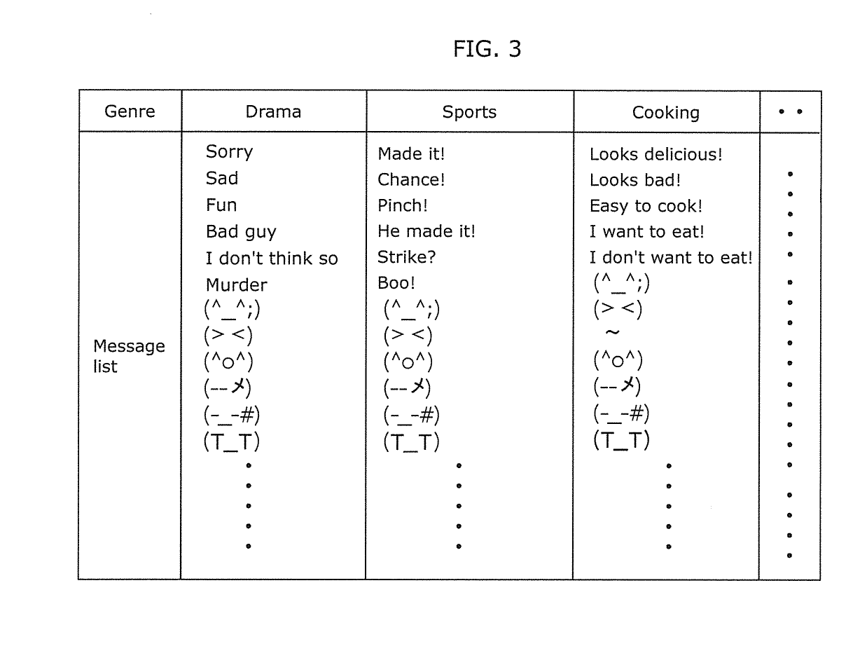

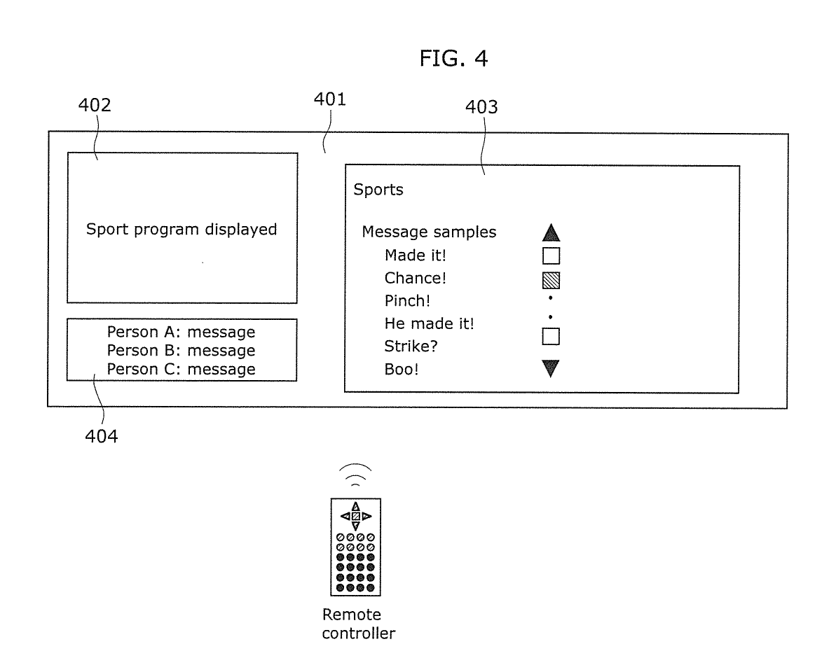

Step S103 is an operation to display a message corresponding to the SI genre. The operation to display a message corresponding to the SI genre includes a step of the message creating unit 10 extracting a specific message sample group from the message sample groups stored in the message sample storing unit 9 based on the genre information included in the SI reproduced by the content reproducing unit 6. FIG. 3 is a diagram showing one example of a data structure stored in the message sample storing unit 9 in the TV-program display apparatus according to Embodiment 1. As in FIG. 3, in the message sample storing unit 9, message samples frequently commented in one genre, drama, such as “Sorry” and “Sad” are stored in correspondence with the genre as one example. The message sample group extracted in the step is converted into the picture data by the message display unit 13. Then, the picture data is synthesized by the picture display unit 14 and displayed in the window generated in Step S101, or displayed in the TV-program displayed in Step S102 as the OSD. FIG. 4 is an image diagram of a display screen in the TV-program display apparatus according to Embodiment 1. In FIG. 4, the TV-program viewing apparatus 2 receives a sport program. In this case, as shown in FIG. 4, the sport program is displayed in a window 402 in the upper left part of a screen 401, and the message sample group corresponding to the sport genre is displayed in a window 403 located in the right of the screen 401.

Step S104 is a step of determining whether the viewer inputs or not. The input from the viewer here means the input related to the operation to select a message described later, and excludes the operation not related to the operation to select a message. The input related to the operation to select a message means pressing of a button if the button explicitly corresponds to the message sample included in the message sample group displayed in Step S103, for example. Alternatively, the input related to the operation to select a message means pressing of a direction key to move a cursor if the viewer finds the cursor that indicates the message sample included in the message sample group displayed in Step S103.

Step S105 is a step of the message creating unit 10 extracting the specific message sample selected by the input, if the viewer inputs in Step S104, from the message sample storing unit 9. In the step, the message creating unit 10 may extract the specific message from the specific message sample group extracted in advance in Step S103 by the message creating unit 10. Thus, the mother set for message extraction may be reduced from the message sample groups stored in the message sample storing unit 9 to the specific message sample group, therefore resulting in high-speed processing.

Step S106 is a step of transmitting the specific message sample extracted in Step S105 via the network 3 to the another TV-program viewing apparatus 4. Specifically, the specific message sample is encoded by the TV-program viewing apparatus control unit 18 according to a specific protocol, modulated by the network interface unit 11, and transmitted to the network 3.

Step S107 is a step of updating the screen to display the state where the specific message sample is transmitted to the another TV-program viewing apparatus 4. Examples of such a state include a method of displaying the messages input by the viewer him/herself in a window 404 in the lower left part of FIG. 4. The step is any step, and the object of the present invention can be attained without particularly updating the screen. When the step is performed, it is advantageous in that the user can check the message input by him/herself.

Step S108 is a step to which the processing goes when no input is obtained for a constant period in Step S104 (NO in Step S104), and a step of checking an input from the another TV-program viewing apparatus 4. Specifically, the TV-program viewing apparatus control unit 18 determines whether the network interface unit 11 receives the message via the network 3 from the another TV-program viewing apparatus 4.

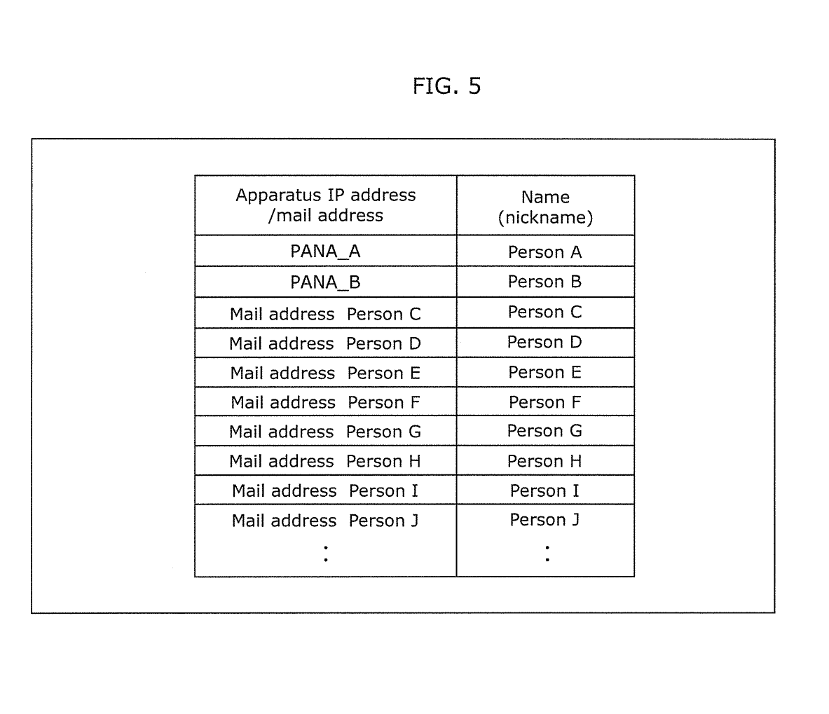

Step S109 is a step of checking which TV-program viewing apparatus transmits the message received in Step S108 among the another TV-program viewing apparatuses 4. FIG. 5 is a diagram showing a table for managing the information on a destination when the TV-program viewing apparatus 2 according to Embodiment 1 exchanges messages. The information is stored in the apparatus information storing unit 15. As shown in FIG. 5, apparatus IP addresses and mail addresses are managed, and names (nicknames) are stored in correspondence with their addresses to prevent transmission of the message by mistake.

Step S107 is a step to which the processing goes after the reception source of the message received in Step S108 is checked in Step S109. Here, Step S107 is a step of updating the screen to display the state where the message is transmitted from the another TV-program viewing apparatus 4. Examples of such a state include a method of displaying a message from some other viewer in the lower left window shown in FIG. 4.

As above, the TV-program viewing apparatus as the message outputting apparatus according to the present embodiment enables input of the message corresponding to the TV-program that the viewer is viewing by a simple method, and messages can be exchanged more easily that in the conventional TV-program viewing apparatus.

### (Modification as System)

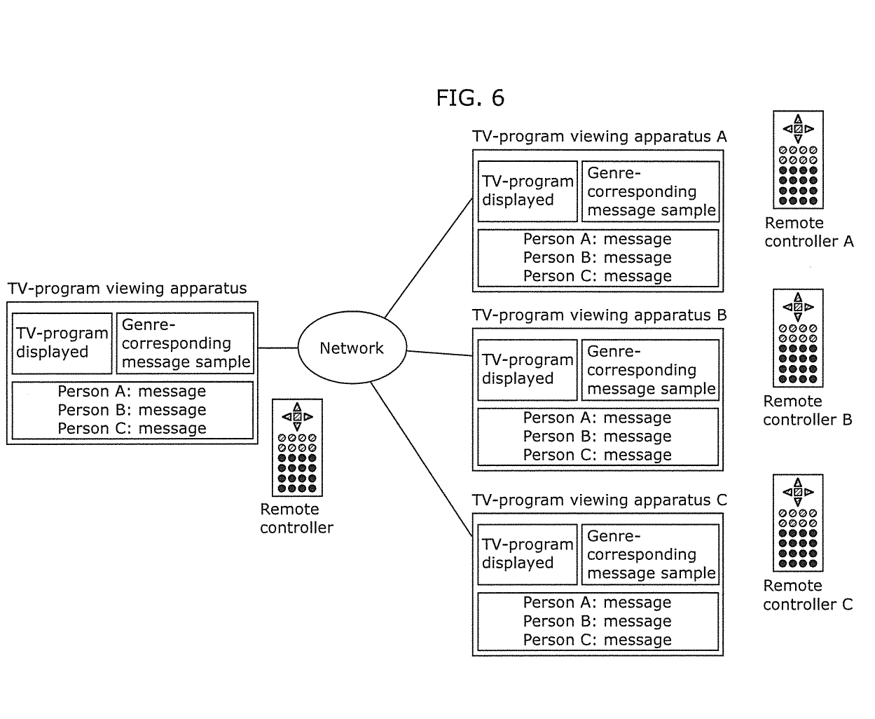

FIG. 6 is a diagram showing an example in which the TV-program viewing apparatus as the message outputting apparatus according to Embodiment 1 is used as a system. In the usage example of the TV-program viewing apparatus described in the present embodiment, it is assumed that a plurality of TV-program viewing apparatuses connected to each other via a network as shown in FIG. 6 operates as a system. Namely, the message is transmitted and received among the plurality of TV-program viewing apparatuses according to the flow described above. Here, in addition of the usage example shown in FIG. 6, another usage example in which the present invention is applicable will be shown.

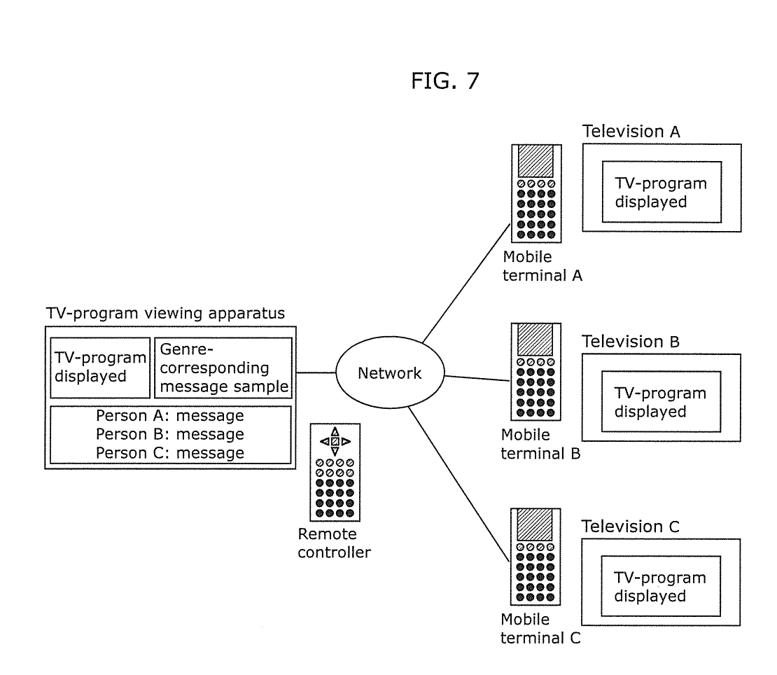

FIG. 7 is a diagram showing a modification as a system of the TV-program viewing apparatus according to Embodiment 1. In FIG. 7 and FIG. 6, the difference is the apparatus connected to the TV-program viewing apparatus as the message outputting apparatus via the network. In other words, in the system in FIG. 7, the apparatus connected to the TV-program viewing apparatus as the message outputting apparatus via the network is a mobile terminal having a function as the message outputting apparatus or television. The TV-program viewing apparatus shown in FIG. 6 has the function as the message outputting apparatus integrated with the function as the TV-program display apparatus. In contrast, in FIG. 7, the system includes a mobile terminal as the message outputting apparatus and a television as the broadcast receiving apparatus, thereby exhibiting the function equivalent to the TV-program viewing apparatus. Such a message outputting apparatus will be described in Embodiment 2 below.

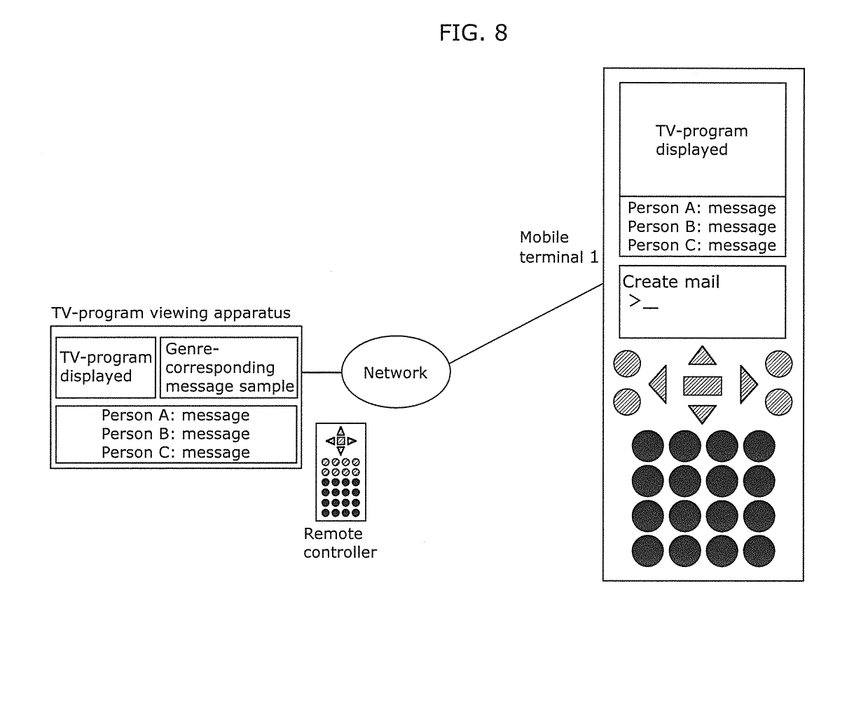

FIG. 8 is a modification as a system of the TV-program viewing apparatus according to Embodiment 1. Unlike FIG. 6, in FIG. 8, the apparatus connected to the TV-program viewing apparatus via the network is the mobile terminal having the function as the TV-program viewing apparatus. In FIG. 8, the mobile terminal has the function to receive the broadcasting and display the message. In a system composed of only mobile terminals, the present invention can also be implemented.

### (Modification 1 of Configuration)

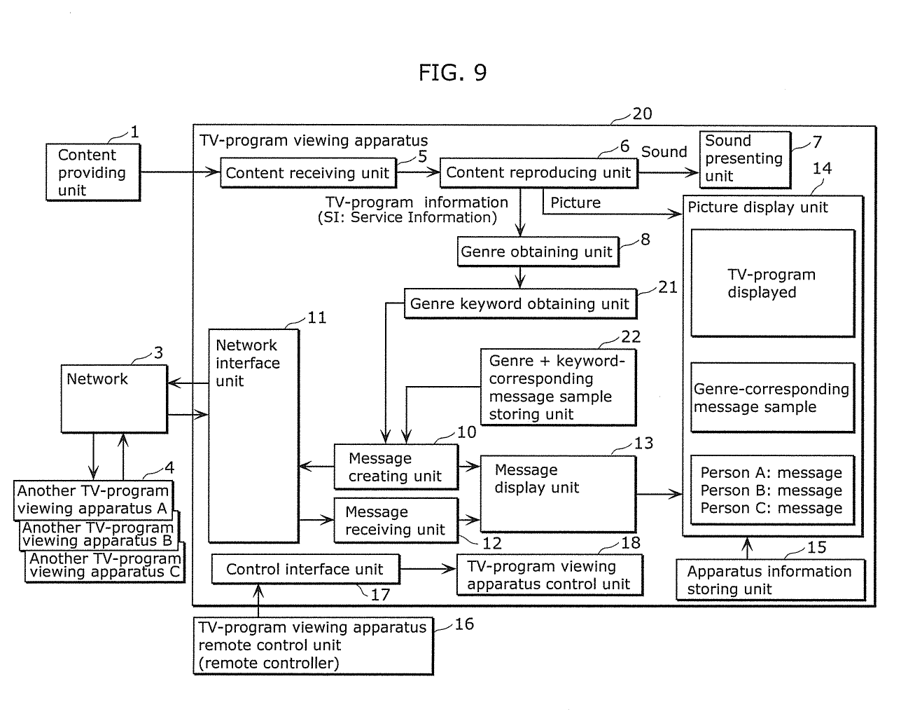

FIG. 9 is a block diagram showing a configuration according to a modification of the TV-program viewing apparatus according to Embodiment 1. A TV-program viewing apparatus 20 shown in FIG. 9 is a TV-program viewing apparatus including the TV-program viewing apparatus 2 shown in FIG. 1, a genre keyword obtaining unit 21 that obtains a genre keyword from the SI of the content, and a genre+keyword-corresponding message sample storing unit 22 that sets a plurality of keywords for each genre in advance, and creates and stores a sample group of messages and words for each of the keywords.

From the SI obtained by the genre obtaining unit 8, the genre keyword obtaining unit 21 obtains a sentence used in an electric TV-program table such as an Electronic Program Guide (EPG), and specifies the keyword using a word or a phrase from the sentence. Here, the keyword is for classification for further limiting the genre. Specifically, if the sentence includes a name of a baseball team or a phrase such as “baseball game on TV,” the keyword baseball is specified from the TV-program. In the specification of the keyword, a mother set as a source for specifying the keyword may be limited using the genre information. The genre and keyword as the criteria for classifying the message sample groups desirably correspond to the genre information extracted by the genre obtaining unit 8 and the genre keyword information extracted by the genre keyword obtaining unit 21, respectively, from the viewpoint of simplification of the system. The genre keyword obtaining unit 21 is implemented by software executed by a CPU such as the TV-program viewing apparatus control unit 18 or dedicated hardware.

In addition to the message samples stored in the message sample storing unit 9, the message samples corresponding to the keyword obtained by the genre keyword obtaining unit 21 are stored in the genre+keyword-corresponding message sample storing unit 22. The genre+keyword-corresponding message sample storing unit 22 is specifically implemented by a storing device such as a RAM and a ROM.

Thus, suitable message samples can be set according to more elaborate classification. Examples of such a method of obtaining a keyword include use of a descriptor freely described in the SI by a broadcast business operator. A predetermined keyword can be extracted from the information to be described in the electric TV-program table.

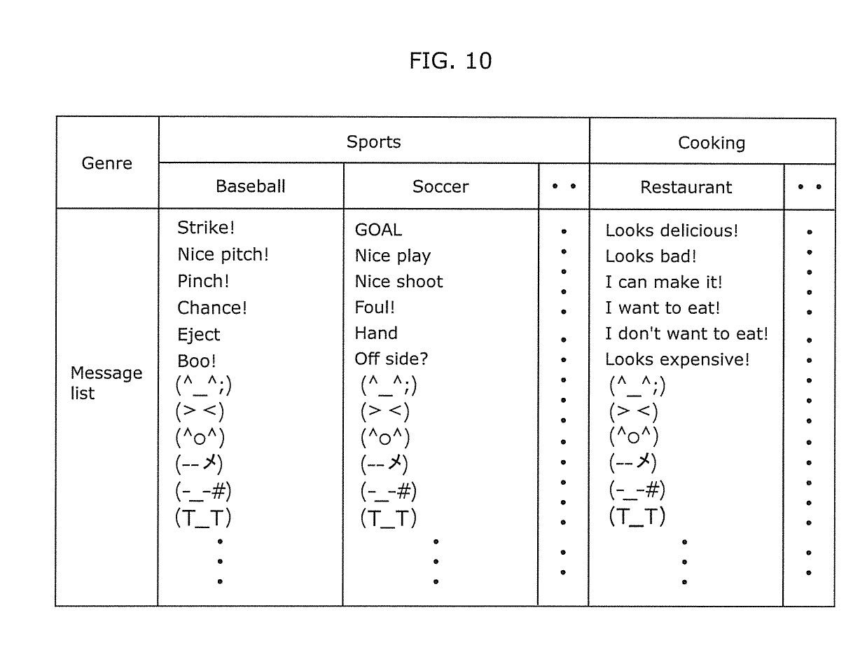

FIG. 10 is a diagram showing one example of a data structure stored in the genre+keyword-corresponding message sample storing unit 22 in the TV-program display apparatus 20 according to Modification 1. As shown in FIG. 10, as one example, the message samples frequently commented such as “Strike!” and “Nice pitch!” are stored in correspondence with a sub-classification item (keyword), baseball in the genre “sports” in the genre+keyword-corresponding message sample storing unit 22.

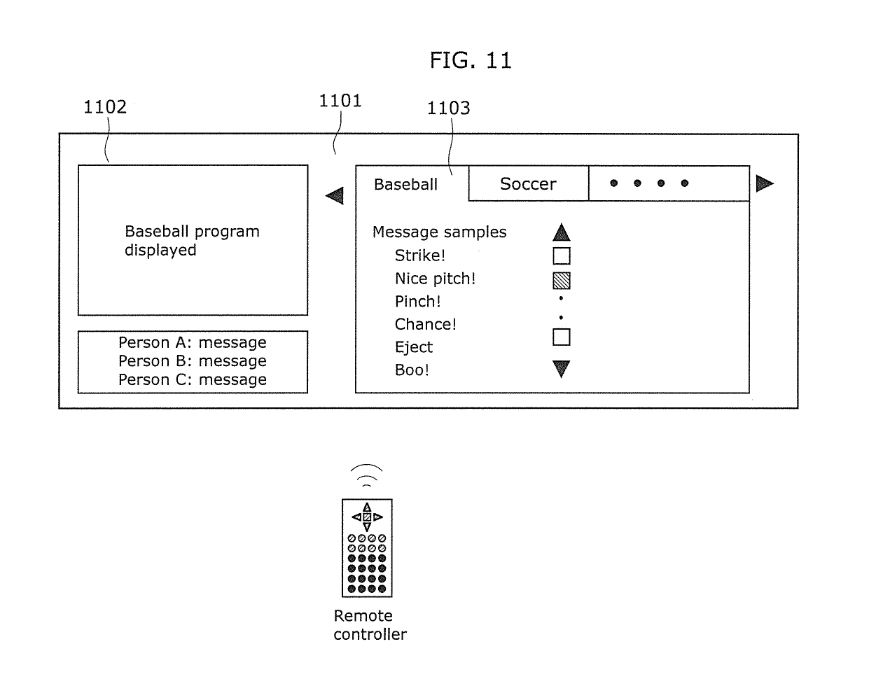

FIG. 11 is an image diagram of a display screen in the TV-program display apparatus according to Modification 1. In Modification 1, when the viewer is viewing a baseball program, the baseball program is displayed in a window 1102 in the upper left part of a screen 1101 as shown in FIG. 11, and the message sample group corresponding to the keyword baseball is displayed in a window 1103 in the right part of the screen 1101. According to Modification 1, the viewer, when viewing the baseball program, can input a message suitable for baseball easily.

### (Modification 2 of Configuration)

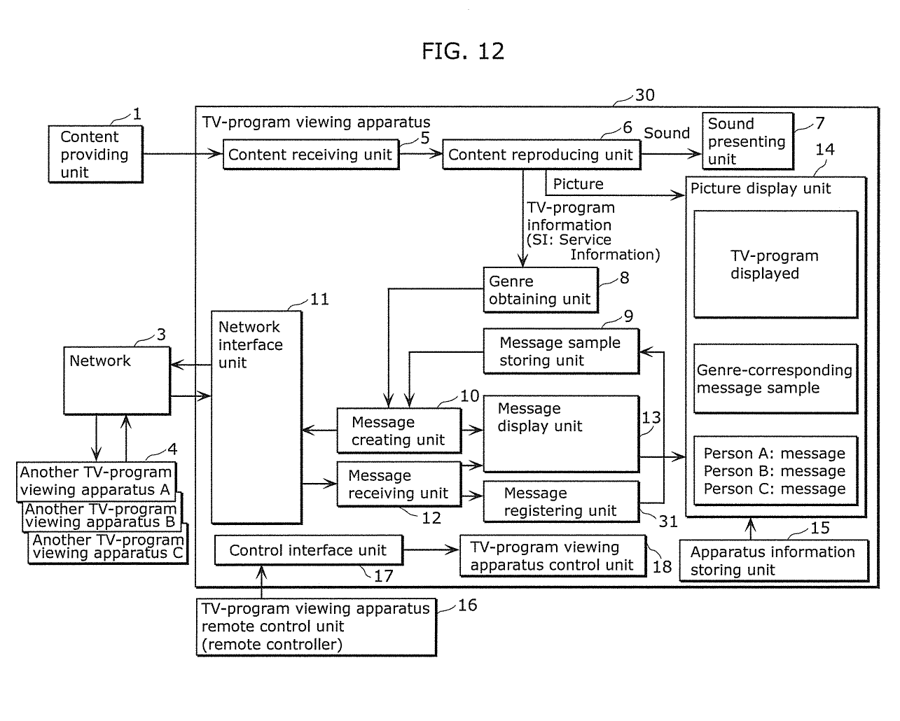

FIG. 12 is a block diagram showing a configuration of a second modification of the TV-program viewing apparatus according to Embodiment 1. A TV-program viewing apparatus 30 shown in FIG. 12 is a TV-program viewing apparatus including the TV-program viewing apparatus 2 shown in FIG. 1 and a message registering unit 31 that registers a new message.

The message registering unit 31 classifies the message received by the message receiving unit 12 according to the genre being viewed, and newly registers the message to the message sample storing unit 9. The message registering unit 31 may be implemented as an independent CPU or a function of the TV-program viewing apparatus control unit 18.

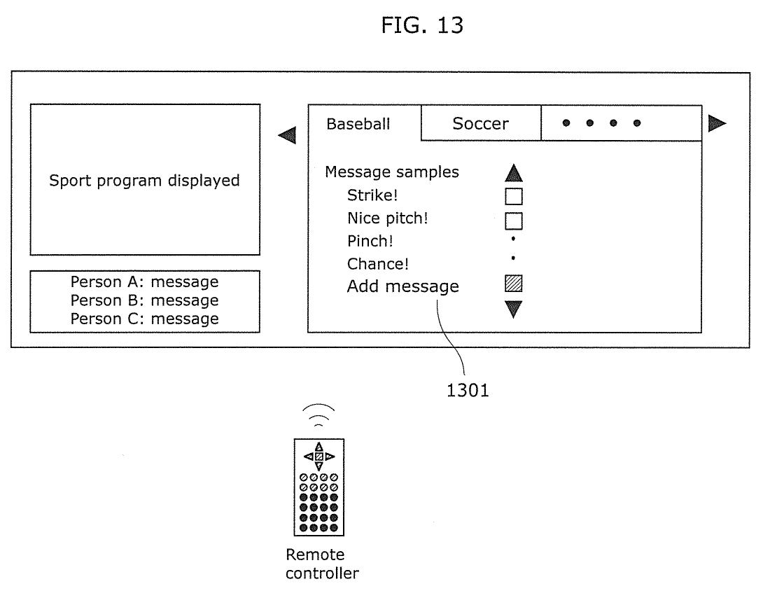

FIGS. 13 to 16 are diagrams showing when Addition of message is selected in the second modification of the TV-program viewing apparatus according to Embodiment 1. Hereinafter, using FIGS. 13 to 16, addition of the message to the message sample group will be described.

First, as shown in FIG. 13, for example, the cursor is moved to an item Selection of message in 1301 with the up-key and the down-key in a cross key provided in a remote controller, and a determination key disposed in the center of the cross key is pressed. Thus, the item Addition of message can be selected.

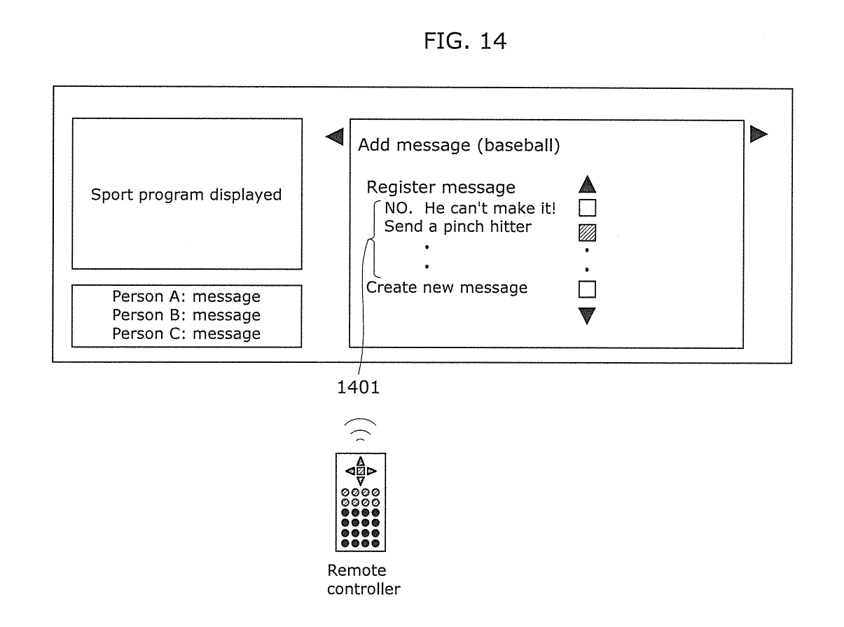

Subsequently, as shown in FIG. 14, the item Addition of message is selected. A message list 1401 of the received messages according to the genre and the keyword is displayed, and a message to be registered is selected with the cross key provided in the remote controller. Thereby, the message registering unit 31 newly registers the selected message in correspondence with the genre being viewed to the message sample storing unit 9.

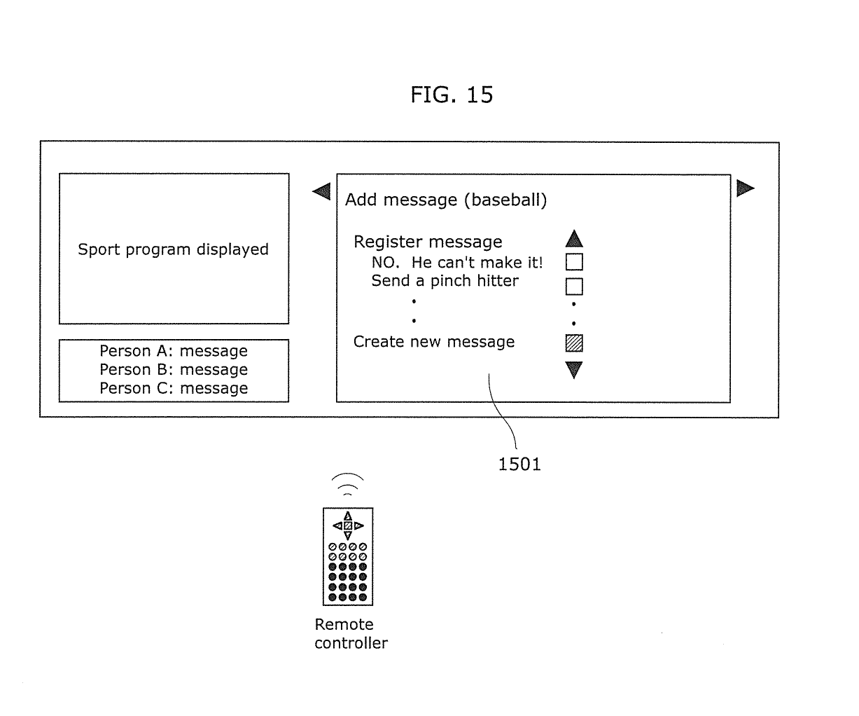

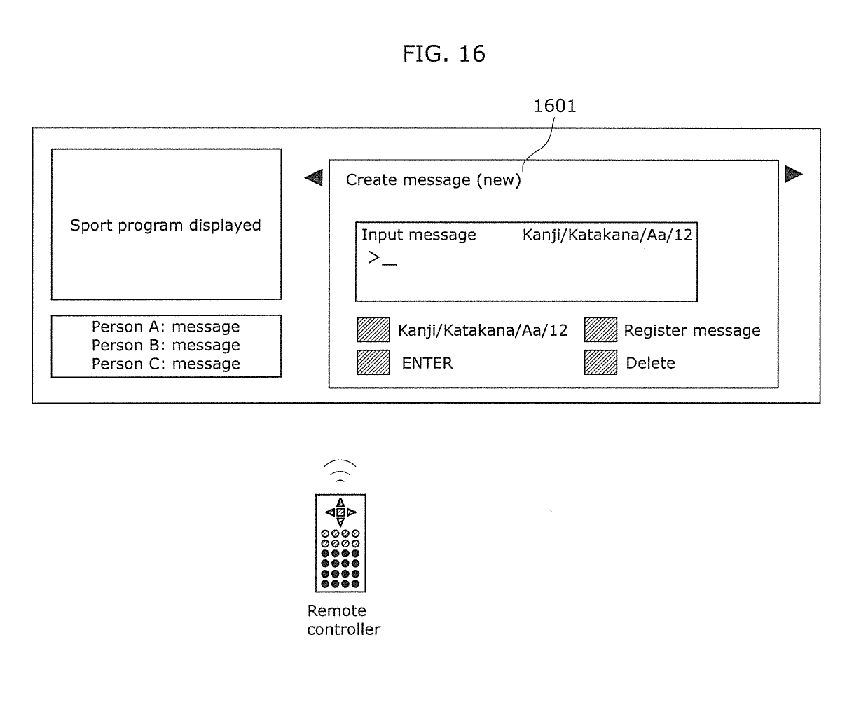

When registration of another new message is desired, as shown in FIG. 15, an item Creation of new message 1501 is selected with the cross key provided in the remote controller. Thereby, the screen is changed to a screen 1601 as shown in FIG. 16. Then, a message is input in the same manner as the input of letters in the mobile phone. Thereby, the message registering unit 31 newly registers the input message in correspondence with the genre being viewed to the message sample storing unit 9.

Here, for example, the type of letters can be selected by pressing a red button in the remote controller. Letters can be deleted with a yellow button. A message can be confirmed with a blue button, and registered with a green button.

As above, by updating the message sample group for convenience, the message can be input more efficiently.

### (Modification 3 of Configuration)

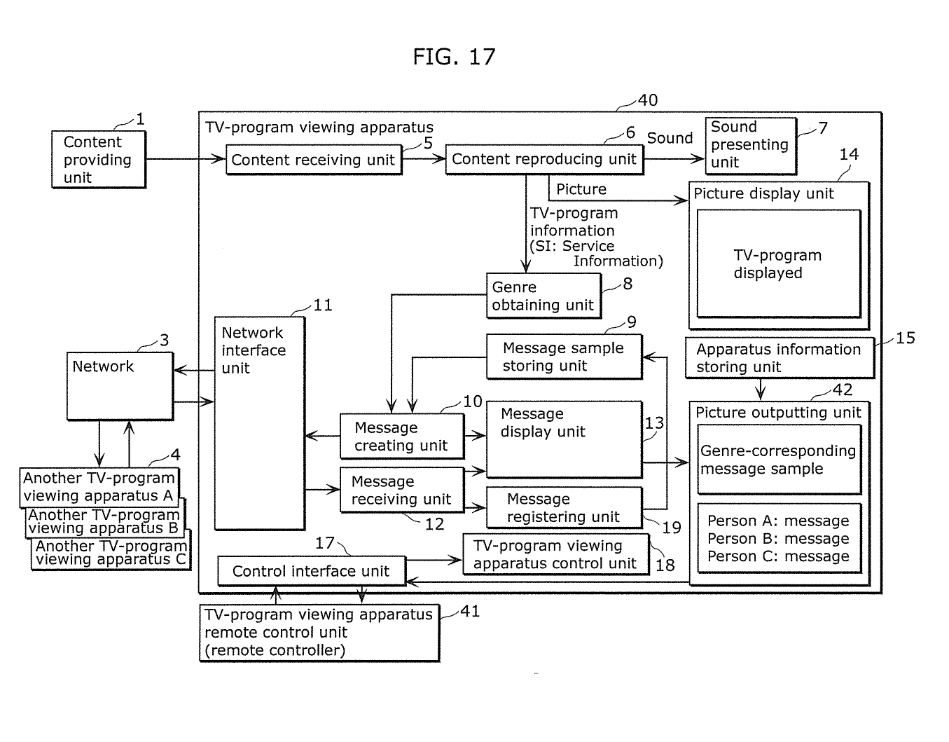

FIG. 17 is a block diagram showing a configuration of a third modification of the TV-program viewing apparatus according to Embodiment 1. Unlike Embodiment 1, the TV-program viewing apparatus 40 displays the message in the TV-program viewing apparatus remote control unit 41.

As a specific difference in the configuration, a TV-program viewing apparatus 40 shown in FIG. 17 includes the TV-program viewing apparatus 2 shown in FIG. 1 and a picture outputting unit 42.

The picture outputting unit 42 outputs the picture generated by the message display unit 13 to the TV-program viewing apparatus remote control unit 41. Examples of a specific method for implementing the picture outputting unit 42 include a method of outputting a picture to the TV-program viewing apparatus remote control unit 41 via the control interface unit 17 as shown in FIG. 17. In this case, the control interface unit 17 is desirably configured with an interface enabling bi-directional communication. For example, the control interface unit 17 desirably includes the existing wireless picture transmission interface such as a wireless LAN and infrared input and output. As another example, without the control interface unit 17, the picture outputting unit 42 itself is configured with the existing wireless picture transmission interface.

### (Modification 4 of Configuration)

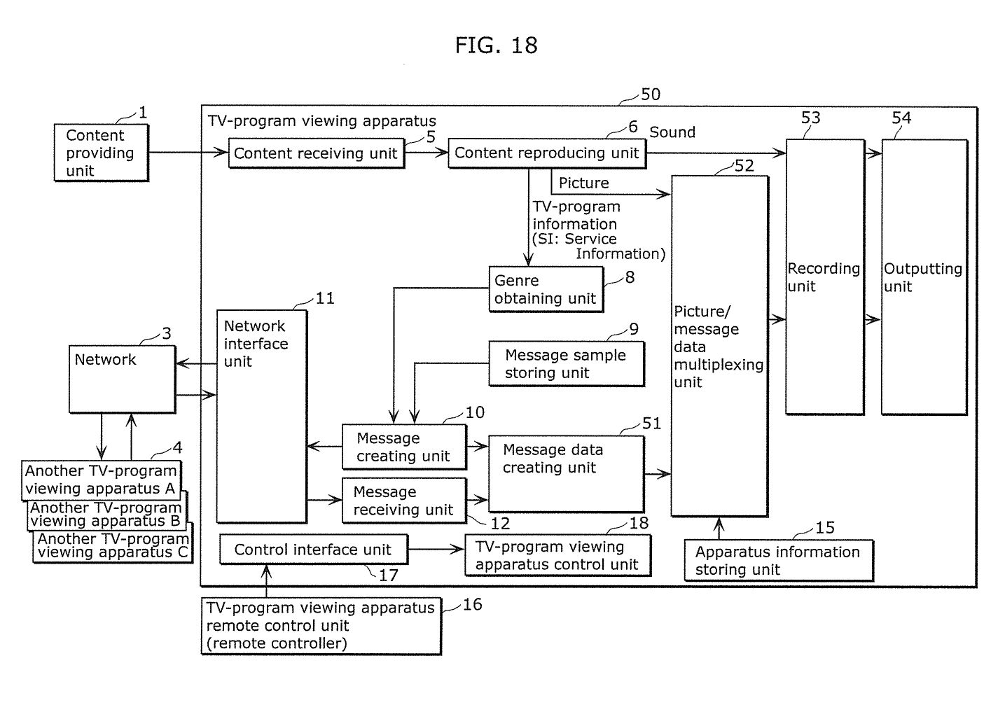

FIG. 18 is a block diagram showing a configuration of the TV-program viewing apparatus according to a fourth modification of Embodiment 1. Unlike Embodiment 1, the TV-program viewing apparatus 50 records the picture sound reproduced by the content reproducing unit 6 and the message created by the message creating unit 10 in a recording unit 53.

As a specific difference in the configuration, a TV-program viewing apparatus 50 shown in FIG. 18 includes the TV-program viewing apparatus 2 shown in FIG. 1, and further includes a message data creating unit 51, a picture/message data multiplexing unit 52, the recording unit 53, and an outputting unit 54.

The message data creating unit 51 converts the message created by the message creating unit 10 into a format recordable in the recording unit 53. Instead of the message data creating unit 51, the data itself created by the message creating unit 10 may have a format directly recordable in the recording unit 53. The message data creating unit 51 may be configured as one function of the TV-program viewing apparatus control unit 18 or as an independent CPU.

The picture/message data multiplexing unit 52 multiplexes the message data for recording created by the message data creating unit 51 and the picture reproduced by the content reproducing unit. At this time, the message data of the picture is multiplexed onto a non-picture portion. For a specific method for configuring the picture/message data multiplexing unit 52, a picture recording type volatility memory such as a frame memory can be used.

The recording unit 53 records the data generated by the picture/message data multiplexing unit 52 and the sound reproduced by the content reproducing unit 6. Examples of a specific method for configuring the recording unit 53 include mass-storage devices such as Hard Disc Drives (HDD).

The outputting unit 54 outputs the sound recorded in the recording unit 53 and the data generated by the picture/message data multiplexing unit 52 to an external apparatus. Specifically, the outputting unit 54 may be implemented by the Ethernet (registered trademark) such as 10Base-T or a wireless LAN interface, or implemented by an interface such as IEEE1394 and a High-Definition Multimedia Interface (HDMI) (registered trademark).

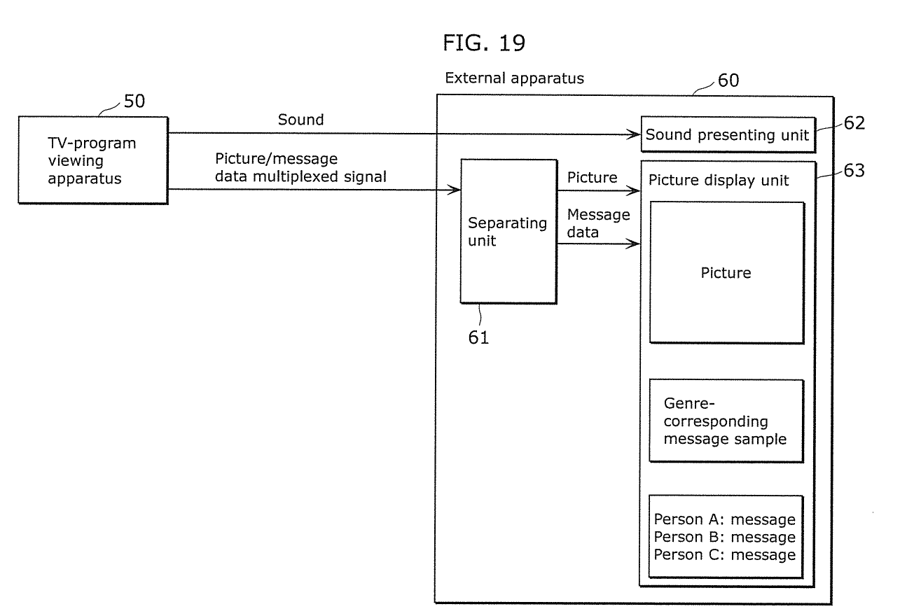

FIG. 19 is a block diagram showing when an output from the TV-program viewing apparatus 50 is viewed with an external apparatus.

The external apparatus 60 receives the sound and the data generated by the picture/message data multiplexing unit 52 (picture/message data multiplexed signal) from the outputting unit 54 in the TV-program viewing apparatus 50.

The separating unit 61 separates the picture and the message data from the picture/message data multiplexed signal. The separating unit 61 is specifically implemented by a CPU, for example.

The sound presenting unit 62 outputs the sound. Specifically, the sound presenting unit 62 is configured with a speaker.

The picture display unit 63 displays the picture and message data separated by the separating unit 61, separately.

Thus, the apparatus on the receiver side can be separated into the TV-program viewing apparatus 50 and the external apparatus 60. Such a configuration increases the freedom in design of the apparatus.

### (Modification 5 of Configuration)

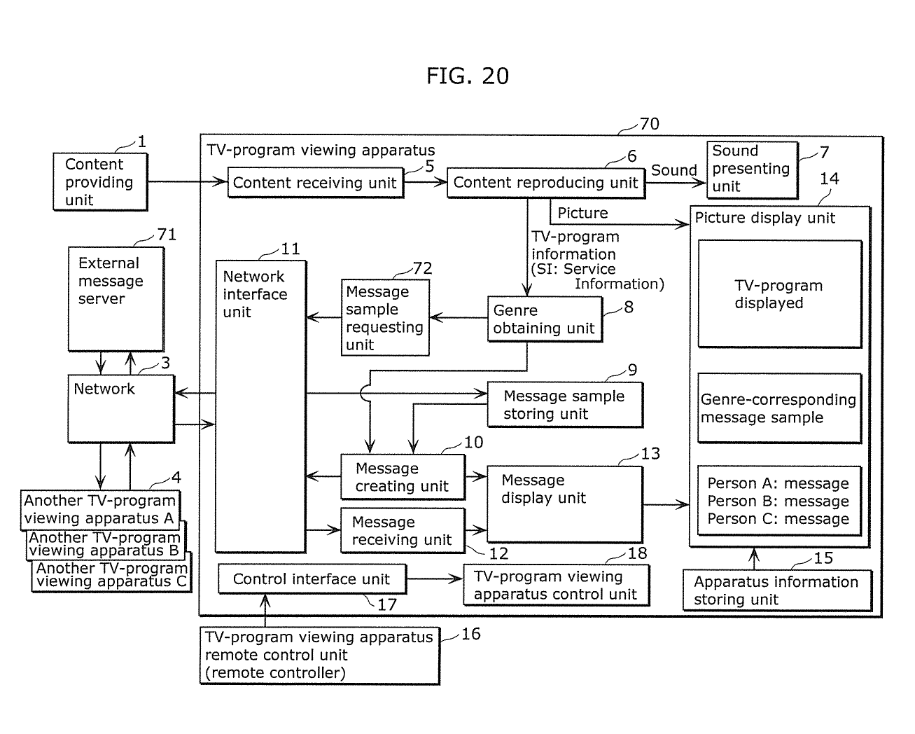

FIG. 20 is a block diagram showing a configuration of a TV-program viewing apparatus according to a fifth modification of Embodiment 1. Unlike Embodiment 1, the TV-program viewing apparatus 70 obtains the message sample group from an external message server 71.

In FIG. 20, the TV-program viewing apparatus 70 controls to cause a message sample requesting unit 72 to transmit a message sample request at a point of time when the genre information is extracted from the TV-program information reproduced by the genre obtaining unit 8 to obtain the genre.

The message sample requesting unit 72 transmits the message sample request to the external message server 71 via the network interface unit 11 and the network 3. The external message server 71 transmits the newest message sample group for the genre in response to the message sample request from the message sample requesting unit 72. The TV-program viewing apparatus 70 receives the newest message sample group via the network 3 and the network interface unit 11, and stores the newest message sample group in the message sample storing unit 9.

In the message sample storing unit 9, messages and word samples are created for each genre and stored in advance similarly to the case of Embodiment 1. In creation of a message, the message is created by the message creating unit 10 using the message sample group obtained from the external message server 71 and the messages and word samples stored in advance for each genre.

In the present modification, by obtaining the message sample group from the external message server 71, the message can be created using the message sample information newer than that in Embodiment 1. This is particularly effective in the case where it is difficult to ensure a sufficient data volume in the TV-program viewing apparatus as in Modification 6 described later.

### (Modification 6 of Configuration)

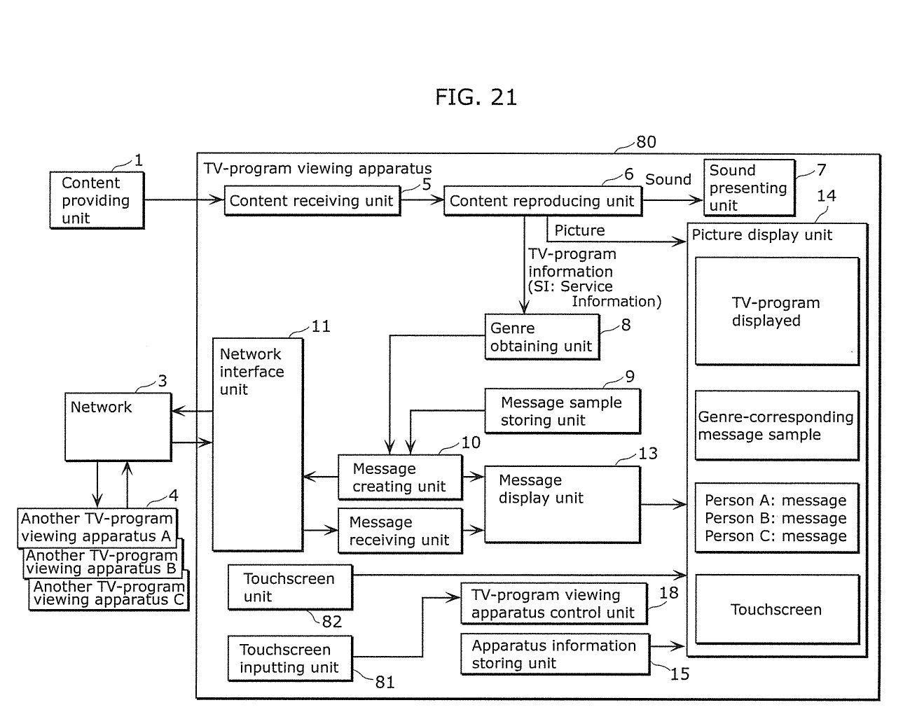

FIG. 21 is a block diagram showing a configuration of the TV-program viewing apparatus according to a sixth modification of Embodiment 1. Unlike Embodiment 1, a TV-program viewing apparatus 80 includes a touchscreen inputting unit 81 and a touchscreen unit 82.

The touchscreen inputting unit 81 is a touchscreen. Specifically, a touchscreen implemented using a capacitive touchscreen panel is adopted.

The touchscreen unit 82 generates the GUI data corresponding to a sensor portion in the touchscreen. Specifically, the touchscreen unit 82 is implemented with a combination of a CPU and a memory, for example.

Such a configuration enables development of the application of the TV-program viewing apparatus into smartphones, allowing exchange of messages between mobiles. Consequently, messages are more actively shared between viewers.

### Embodiment 2

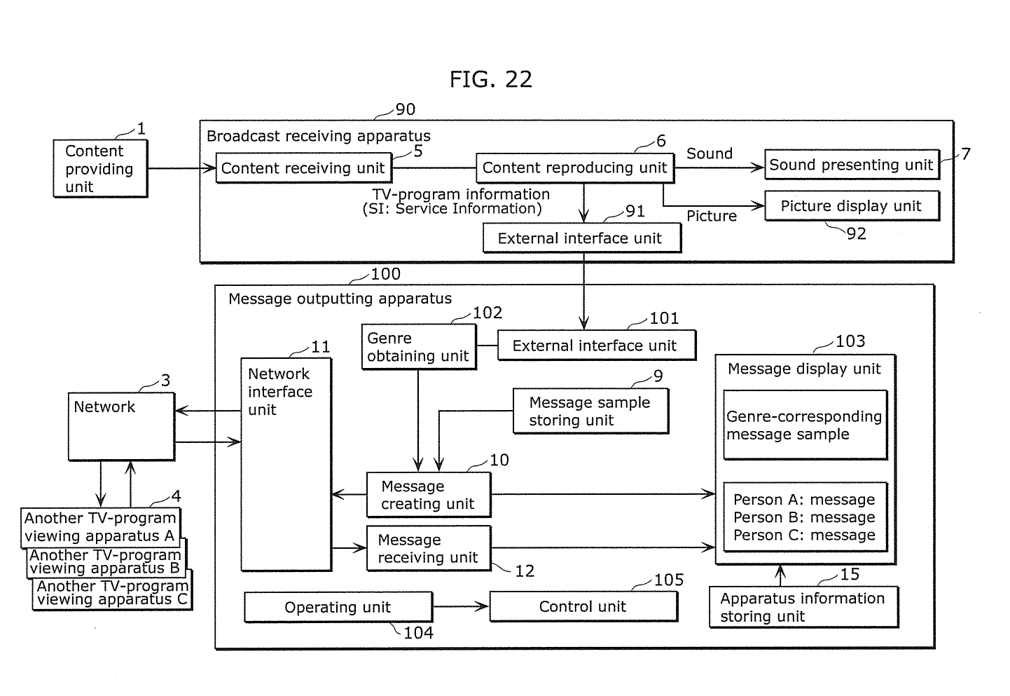

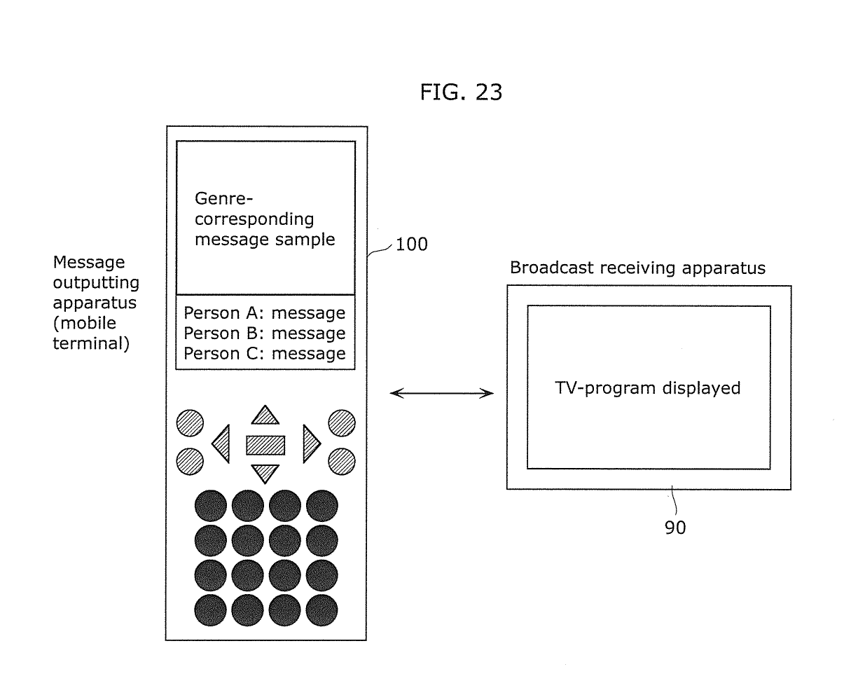

FIG. 22 is a block diagram showing a configuration of a message outputting apparatus, broadcast receiving apparatus, and its peripheral apparatuses according to one embodiment of the present invention. FIG. 23 is a diagram showing a usage example of the message outputting apparatus and the broadcast receiving apparatus. Same reference numerals are given to components identical to those in Embodiment 1, and the description is omitted.

A message outputting apparatus 100 is an apparatus for outputting a message by the user when with a broadcast receiving apparatus 90, the user is viewing the content (TV-program) provided from the content providing unit 1 by the way of broadcasting or communication. As shown in FIG. 22, the message outputting apparatus 100 includes a message sample storing unit 9, a message creating unit 10, a network interface unit 11, a message receiving unit 12, an apparatus information storing unit 15, an external interface unit 101, a genre obtaining unit 102, a message display unit 103, an operating unit 104, and a control unit 105. Examples of the message outputting apparatus 100 include PCs and mobile phones.

The external interface unit 101 is an interface that transmits and receives the data to and from a display device that displays the content. Specifically, the external interface unit 101 is implemented with the Ethernet (registered trademark) such as 10Base-T or a wireless Local Area Network (LAN) interface, for example. In the present embodiment, the broadcast receiving apparatus 90 is the display device that displays the content.

The genre obtaining unit 102 obtains the TV-program information (SI) of the content displayed in the broadcast receiving apparatus 90 from the broadcast receiving apparatus 90 via the external interface unit 101. The genre obtaining unit 102 extracts the genre information from the TV-program information. Another configuration may be adopted in which the genre information is extracted from the TV-program information in the broadcast receiving apparatus 90, and the genre obtaining unit 102 obtains the genre information.

The message sample group extracted by the message display unit 103 and the message creating unit 10 and the message received by the message receiving unit 12 are displayed on the display screen.

The operating unit 104 is an interface for inputting to the message outputting apparatus 100. Typically, the operating unit 104 is buttons included in the message outputting apparatus 100, for example.

The control unit 105 interprets a command input from the operating unit 104, and controls the functional blocks in the message outputting apparatus 100 described above. The output from the control unit 105 is connected to the functional blocks in the message outputting apparatus 100, but not shown to avoid complexity of the diagram. Examples of the control of the storing blocks in the message outputting apparatus 100 by the control unit 105 include management of a storing region such as a RAM and a ROM, management of the timings to input and output the data, and management of interrupt control.

The broadcast receiving apparatus 90 is an apparatus for viewing the content provided from the content providing unit 1 by the way of broadcasting or communication, and includes the content receiving unit 5, the content reproducing unit 6, the sound presenting unit 7, an external interface unit 91, and a picture display unit 92. Examples of the broadcast receiving apparatus 90 include television receivers, Set Top Boxes (STP), and PCs.

The external interface unit 91 is an interface that transmits and receives the data to and from the message outputting apparatus 100. Specifically, the external interface unit 91 is implemented with the Ethernet (registered trademark) such as 10Base-T or a wireless Local Area Network (LAN) interface, for example.

When the broadcast receiving apparatus 90 includes a display, the picture display unit 92 displays the picture of the content received by the content receiving unit 5 on the display. When the broadcast receiving apparatus 90 is connected to a display wiredly or wirelessly, the picture display unit 92 outputs the picture to the display and displays the picture on the display.

In the thus-configured message outputting apparatus 100, the operation to input a message for the TV-program from the user, transmit the message to the outside, and simultaneously receive the message for the TV-program when the user is viewing the content (TV-program) with the broadcast receiving apparatus 90 will be described.

When the user is viewing the TV-program with the broadcast receiving apparatus 90 and a chat application or application equivalent to a chat application (such as an instant messenger) is launched from the operating unit 104, the genre obtaining unit 102 obtains the TV-program information of the content displayed in the broadcast receiving apparatus 90 from the broadcast receiving apparatus 90 via the external interface unit 101.

The operation subsequent to this is identical to that after Step S103 in the flowchart shown in FIG. 2, and the description is omitted.

Thereby, the message outputting apparatus can be configured as a mobile terminal, allowing easy exchange of messages between mobiles. Consequently, messages are more actively shared between viewers.

### INDUSTRIAL APPLICABILITY

The message outputting apparatus according to the present invention can transmit a message suitable for a TV-program by simple operation when the user is viewing the TV-program, enabling active sharing of messages between viewers. For example, the message outputting apparatus according to the present invention is useful in transmission of the message using television receivers, Set Top Boxes (STB), mobile phones, and personal computers.

### REFERENCE SIGNS LIST

1 Content providing unit
2, 20, 30, 40, 50, 70, 80 TV-program viewing apparatus
3 Network
4 Another TV-program viewing apparatus
5 Content receiving unit
6 Content reproducing unit
7 Sound presenting unit
8 Genre obtaining unit
9 Message sample storing unit
10 Message creating unit
11 Network interface unit
12 Message receiving unit
13 Message display unit
14 Picture display unit
15 Apparatus information storing unit
16 TV-program viewing apparatus remote control unit
17 Control interface unit
18 TV-program viewing apparatus control unit
21 Genre keyword obtaining unit
22 Genre+keyword-corresponding message sample storing unit
31 Message registering unit
41 TV-program viewing apparatus remote control unit
42 Picture outputting unit
51 Message data creating unit
52 Picture/message data multiplexing unit
53 Recording unit
54 Outputting unit
60 External apparatus
61 Separating unit
62 Sound presenting unit
63 Picture display unit
71 External message server
72 Message sample requesting unit
81 Touchscreen inputting unit
82 Touchscreen unit
90 Broadcast receiving apparatus
91 External interface unit
92 Picture display unit
100 Message outputting apparatus
101 External interface unit
102 Genre obtaining unit
103 Message display unit
104 Operating unit
105 Control unit

1. A message outputting apparatus that outputs a message when a user is viewing content, the message outputting apparatus comprising:
a genre obtaining unit configured to obtain genre information of the content;
a message sample storing unit configured to store one or more message samples in correspondence with the genre information;
a message creating unit configured to extract at least one message sample as a message sample group from the one or more message samples stored in the message sample storing unit, based on the genre information obtained by the genre obtaining unit;
a control interface unit configured to accept an input from the user;
a network interface unit configured to transmit and receive data to and from an external apparatus; and
a control unit configured to specify a specific message sample from the message sample group extracted by the message creating unit, based on the input from the user accepted by the control interface unit, and output data corresponding to the specific message sample to the external apparatus via the network interface unit.

2. The message outputting apparatus according to claim 1, further comprising:
a content receiving unit configured to receive the content; and
a content reproducing unit configured to reproduce a picture and TV-program information including the genre information from the content received by the content receiving unit,
wherein the genre obtaining unit is configured to obtain the genre information from the TV-program information.

3. The message outputting apparatus according to claim 1, further comprising:
a message display unit configured to display the message sample group extracted by the message creating unit.

4. The message outputting apparatus according to claim 2, further comprising:
a picture display unit configured to generate a picture in which the picture reproduced by the content reproducing unit is synthesized with the message sample group extracted by the message creating unit.

5. The message outputting apparatus according to claim 1, further comprising:
an external interface unit configured to transmit and receive data to and from a display device that displays the content,
wherein the genre obtaining unit is configured to obtain the genre information of the content from the display device via the external interface unit, the content being displayed with the display device.

6. The message outputting apparatus according to claim 1, further comprising:
a message sample requesting unit configured to obtain one or more message samples as the message sample group via the network interface unit from an external apparatus, based on the genre information obtained by the genre obtaining unit.

7. The message outputting apparatus according to claim 1,
wherein the message sample storing unit is configured to store the message sample in correspondence with a genre and a genre keyword,
the message outputting apparatus further comprises a genre keyword obtaining unit configured to obtain the genre keyword for the content, and
the message creating unit is configured to extract one or more message samples as a message sample group from the one or more message samples stored in the message sample storing unit, based on the genre keyword obtained by the genre keyword obtaining unit.

8. The message outputting apparatus according to claim 1, further comprising:
a message registering unit configured to register the message to the message sample storing unit as the message sample in correspondence with the genre based on the genre information obtained by the genre obtaining unit, the message being based on the input from the user and accepted by the control interface unit.

9. The message outputting apparatus according to claim 1, further comprising:
a message receiving unit configured to receive a message from the external apparatus via the network interface unit; and
a message registering unit configured to register the message received by the message receiving unit to the message sample storing unit as the message sample in correspondence with the genre based on the genre information obtained by the genre obtaining unit.

10. A message outputting method for outputting a message when a user is viewing content, the message outputting method comprising:
obtaining genre information of the content;
extracting at least one message sample as a message sample group from one or more message samples stored in correspondence with the genre information, based on the obtained genre information;
accepting an input from the user; and
specifying a specific message sample from the message sample group based on the input from the user, and outputting data corresponding to the specific message sample to an external apparatus.
